(19) United States
(12) Patent Application Publication
(10) Pub. No.: US 2022/0160154 A1
(43) Pub. Date: May 26, 2022

(54) DOUBLE-WALL COOLING APPARATUS FOR USE WITH A BEVERAGE CONTAINER

(71) Applicant: Kin Wang Chan, Hong Kong (HK)

(72) Inventor: Kin Wang Chan, Hong Kong (HK)

(73) Assignee: kin Wang Chan, Hong Kong (HK)

(21) Appl. No.: 17/100,986

(22) Filed: Nov. 23, 2020

(51) Int. Cl. A47G 23/02; B65D 41/04; B65D 51/24; B67B 7/16; A47J 41/00

(52) U.S. Cl. CPC A47G 23/0241; B65D 41/04; B65D 51/243; B67B 7/16; A47J 41/02; A47J 41/0061; A47J 41/0083; A47G 2023/0275; A47G 23/0266

(57) ABSTRACT

Disclosed is a double-wall cooling apparatus for use with a beverage container to keep the beverage or cold drinks cold for hours. The double-wall cooling apparatus includes a bottom section, a top section, and a twist-lock. The bottom section haying a cylindrical shape to conform to the shape of the beverage container. The bottom section comprises a closed bottom portion and an open-top portion. The top section being inwardly contracted at the top to form an opening. The twist-lock secures be top section and the bottom section. The bottom section and the top seem are detachably connected therewith.

### TECHNICAL FIELD

The presently disclosed embodiments are related, in general, to a beverage cooling apparatus to hold beverage containers. More particularly, the presently disclosed embodiments are related to a double-wall cooling apparatus for use with a beverage container to keep the beverage cold for hours.

### BACKGROUND

Devices and apparatus to hold the beverage containers to keep the beverage cold are well known in the art, especially of the type dimensioned to telescopically receive the beverage container in an arrangement in which the upper marginal edge of the beverage container above the top of the device to facilitate consumption of the beverages, including beer, soft drinks, and fruit juices,

US patent publication 20130240549 A1 filed by Beggins et al. discloses an insulating holder for holding a beverage in a bottle or a can having a lower cylindrical enclosure which receives an upper cylindrical enclosure having a dome-shaped upper end. The upper cylindrical enclosure is adapted to cover the top portion of a bottle inserted into the lower cylindrical enclosure and to Snuggly receive a can when inverted and inserted into the lower cylindrical enclosure. At least a portion of the lower cylindrical enclosure or upper cylindrical enclosure is made of a polyolefin elastomer foam. The insulating holder may be structured to retain various sizes of wine bottles.

U.S. Pat. No. 10,251,468 B1 issued to Moore et al. describes an insulated beverage protector for sealing and storing an open bottle comprised of: (i) a body having at least two sections (a) an upper section that is tapered and configured to snugly surround the tapered neck of the bottle and (b) a base section configured to snugly surround the cylindrical base of the bottle; (ii) a cover that removably attaches to the body; (iii) a stopper (stored within die cover) that removably attaches to the inside, the top-most surface of the cover.

Further, there are various can and bottle coolers produced by Asobu, BrüMate, and Grand fusion housewares store. Asobu has a frosty beer 2 go which acts as a beer chiller combination for beer bottles and beer cans. BrüMate has a HOPSULATOR TRIO 3-in-1 stainless steel insulated can cooler to keep the beer icy-cold. The HOPSULATOR TRIO fits all 16 oz cans, including the arctic adapter gel pack that enables use with standard 12 oz cans, and has a capacity of 16 oz so the user can use it as a pint glass. Grand fusion housewares store has a 3 in 1 insulated stainless steel vacuum-sealed beer bottle, can and water cooler with opener.

It is desirable to provide a device or apparatus of keeping the beverages cool while it is being consumed, because these beverage containers warm up quickly through their conductive walls, drawing heat from the hand that holds them as well as from the atmosphere. This specification recognizes that there is a need for a double-wall cooling apparatus for use with a beverage container to keep the beverage or cold drinks cold for hours.

Further limitations and disadvantages of conventional and traditional approaches will become apparent to one of skill in the art, through comparison of described systems with some aspects of the present disclosure, as outlined in the remainder of the present application and with reference to the drawings.

### SUMMARY

According to embodiments illustrated herein, there may be provided a double-wall cooling apparatus for use with a beverage container to keep the beverage or cold drinks cold for hours. The double-wall cooling apparatus includes a bottom section, a top section, a twist-lock, a raiser, a gasket, a cap assembly, and a built-in bottle opener. The bottom section having a cylindrical shape to conform to the shape of the beverage container. The bottom section comprises a closed bottom portion and an open-top portion. The top section being inwardly contracted at the top to form an opening. The twist-lock secures the top section and the bottom section. The bottom section and the top section are detachably connected therewith.

In an aspect, the raiser is placed at the closed bottom portion of the bottom section to raise the height of the beverage container having a size of 12 oz or below so that opening of the beverage container is above the open-top portion of the bottom section.

In an aspect, the gasket adaptable to securely hold the beverage container onto the bottom section.

In an aspect, the cap assembly having an internally threaded skirt for closing an opening end of the beverage container.

In an aspect, the cap assembly comprises a built-in battle opener.

In an aspect, the built-in battle opener is placed on a top part of the cap assembly to facilitate a user to open the beverage container.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The accompanying drawings illustrate the various embodiments of systems, methods, a other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In same examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates an assembled view of a double-wall cooling apparatus, in accordance with at least one embodiment.

FIG. 2 illustrates a perspective view of a top section of the double-wall cooling apparatus, in accordance with at least one embodiment.

FIG. 3 illustrates a perspective view of a bottom section of the double-wall cooling apparatus, in accordance with at least one embodiment.

FIG. 4 illustrates an exploded view of the double-wall cooling apparatus, in accordance with at least sine embodiment.

FIG. 5 illustrates a perspective view of a cap assembly of the double-wall cooling apparatus, in accordance with at least one embodiment.

FIG. 6 illustrates an exploded view of the cap assembly of the double-wall cooling apparatus, in accordance with at least one embodiment.

FIG. 7 illustrates a perspective view of a raiser of the double-wall cooling apparatus, in accordance with at least one embodiment.

FIG. 8 illustrates a perspective view of a gasket of the double-wall cooling, apparatus, in accordance with at least one embodiment.

FIG. 9 illustrates a first perspective view of a double-wall cooling apparatus for use with a bottle of 12 oz (ounces) size or below, in accordance with at least one embodiment.

FIG. 10 illustrates a second perspective view of a double-wall cooling apparatus for use with a bottle of 16 oz (ounces) size, in accordance with at least one embodiment.

FIG. 11 illustrates a third perspective view of a double-wall cooling apparatus for use with a bottle, in accordance with at least one embodiment.

FIG. 12 illustrates a first perspective view of a double-wall cooling apparatus for use with a can, in accordance with at least one embodiment.

FIG. 13 illustrates a second perspective view of a double-wall cooling apparatus for use with a can, in accordance with at least one embodiment.

FIG. 14 illustrates a third perspective view of a double-wall cooling apparatus for use with a can in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods, and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

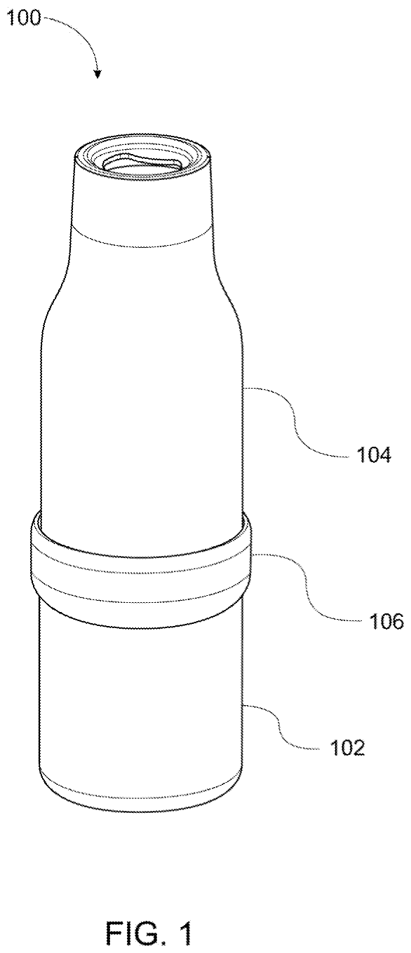

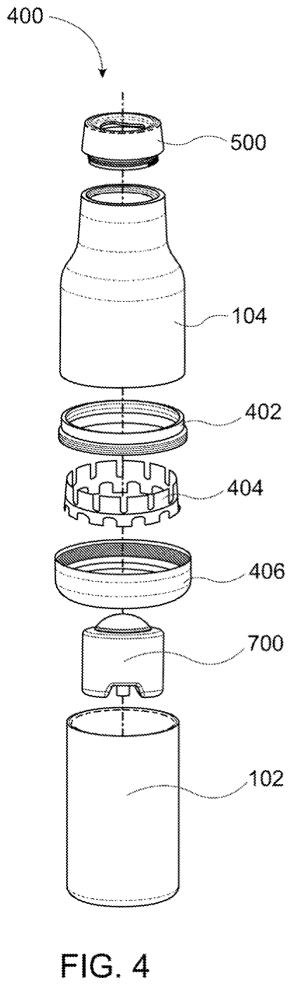

FIG. 1 illustrates an assembled view of a double-wall cooling apparatus 100, in accordance with at least one embodiment. In an embodiment, the double-wall cooling apparatus 100 is an insulated container to hold a beverage container to keep the beverage cold for hours. Examples of the beverages include but are not limited to beer, water, milk, coffee, tea, soft drinks, and fruit. juices. Examples of the beverage container include but are not limited to a bottle, a can, and a tumbler. The double-wall cooling apparatus 100 is made of stainless steel. According to an embodiment herein, the double-wall cooling, apparatus 100 is made of food-grade double-wall insulated stainless steel to keep the beverage cold for hours. In an embodiment, the double-wall cooling apparatus 100 is vacuum structured from inside the double-wall to provide cold beverages for hours. The double-wall cooling apparatus 100 is suitable for keeping bottles, cans, and tumblers of different shapes and sizes. FIG. 4 illustrates an exploded view 400 of the double-wall cooling apparatus, in accordance with at least one embodiment. FIG. 4 is explained in conjunction with FIG. 1. The double-wall cooling apparatus 100 includes a bottom section 102, a top section 104, a twist-lock 106, a raiser 700, a gasket 800 (shown in FIG. 8), a cap assembly 500, a built-in bottle opener 602 (shown in FIG. 6), a nut base 402, a ring 404 and a nut 406. In an embodiment, the nut base 402, ring 404, and nut 406 are made of plastic material.

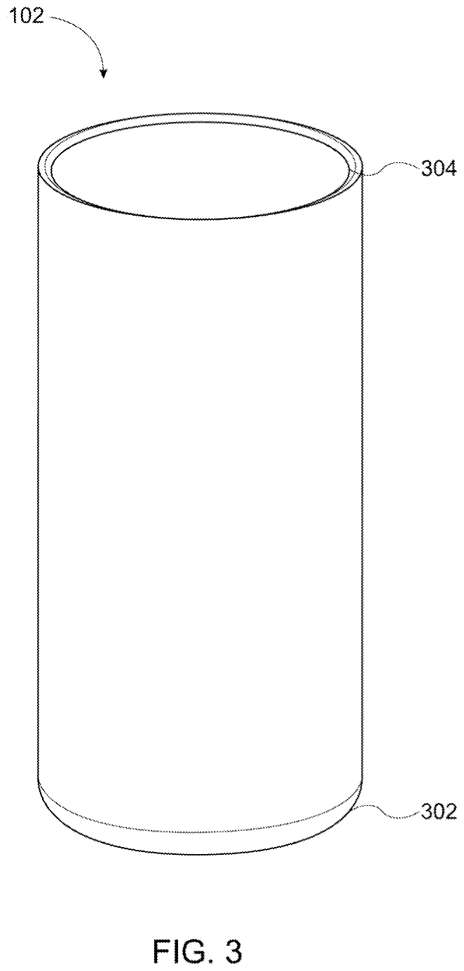

FIG. 3 illustrates a perspective view of as bottom section 102 of the double-wall cooling apparatus, in accordance with at least one embodiment. FIG. 3 is explained in conjunction with FIG. 1. The bottom section 102 having a cylindrical shape to conform to the shape of the beverage container. The bottom section 102 includes a closed bottom portion 302 and an open-top portion 304.

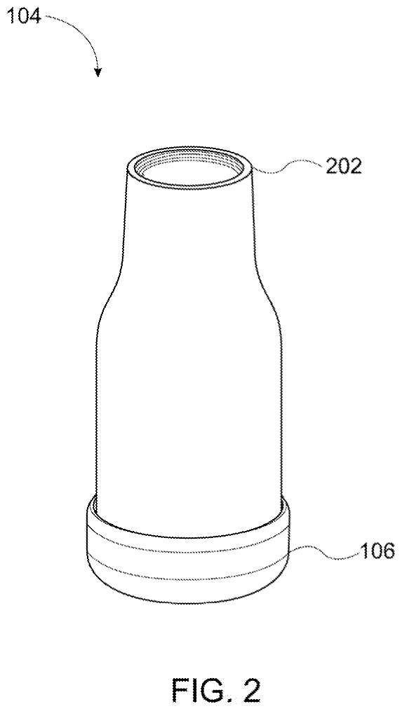

FIG. 2 illustrates a perspective view of a top section 104 of the double-wall cooling apparatus, in a accordance with at least one embodiment. FIG. 2 is explained in conjunction with FIG. 1. The top section 104 being inwardly contracted at the top to form an opening 202. The twist-lock secures the top section and the bottom section. The bottom section 102 and the top section 104 are detachably connected therewith.

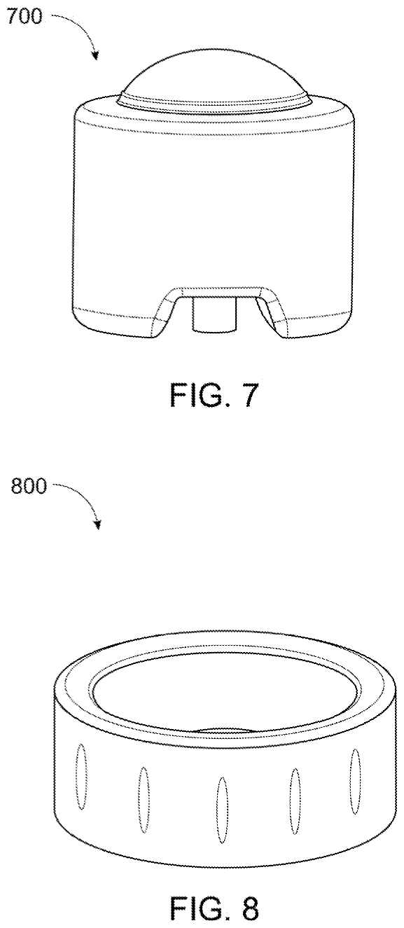

FIG. 7 illustrates a perspective view of a raiser 700 of the double-wall cooling apparatus, in accordance with at least one embodiment. The raiser 700 is placed at the closed bottom portion 302 of the bottom section 102 to raise the height of the beverage container having a size of 12 oz or below so that opening of the beverage container is above the open-top portion of the bottom section 102.

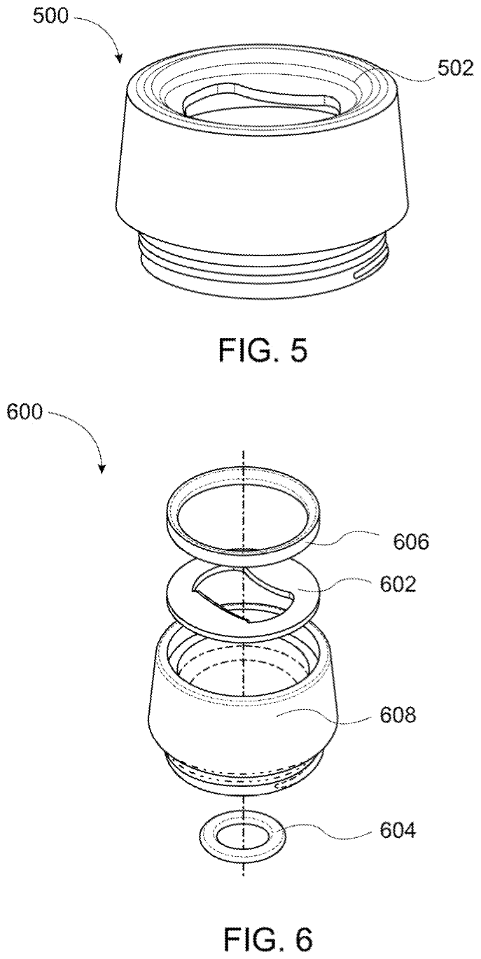

FIG. 8 illustrates a perspective view of a gasket 800 of the double-wall cooling apparatus, in accordance with at least one embodiment. The gasket 800 is adaptable to securely hold the beverage container onto the bottom section 102. FIG. 5 illustrates a perspective view of a cap assembly 500 of the double-wall cooling apparatus, in accordance with at least one embodiment. The cap assembly 500 having an internally threaded skirt 502 for closing an opening end of the beverage container. FIG. 6 illustrates an exploded view 600 of the cap assembly of the double-wall cooling apparatus, in accordance with at least one embodiment. FIG. 6 is explained in conjunction with FIG. 5. The cap assembly 500 includes a built-in bottle opener 602, a bottom part 604, a top part 606, and a sealing 608. The built-in bottle opener 602 is placed on the top part 606 of the cap assembly to facilitate a user to open the beverage container. The built-in bottle opener 602 is made of steel material. The bottom part 604 and the top part 606 of the cap assembly 500 are made of plastic material. The sealing 608 of the cap assembly 500 is made of silicone.

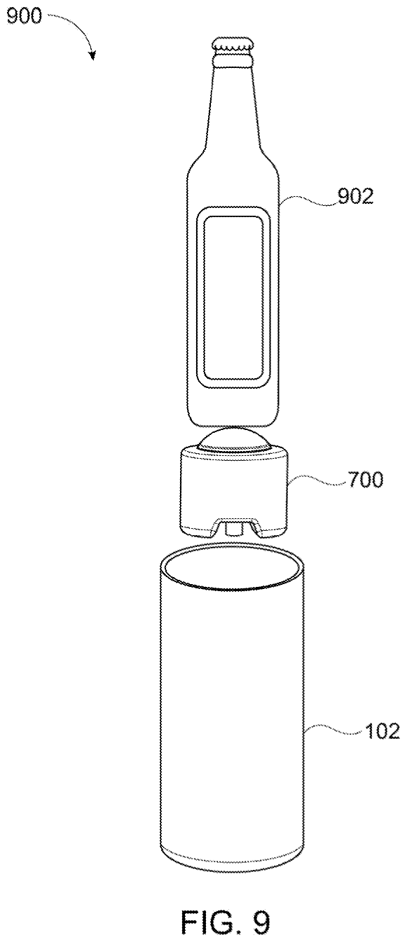

FIG. 9 illustrates a first perspective view 900 of a double-wall cooling apparatus for use with a bottle of 12 oz (ounces) 902 size or below, in accordance with at least one embodiment. In case, the double-wall cooling apparatus 100 is used with the bottle of 12 oz 902, the user has to pull the top section front the bottom section 102 to separate the two components. For the 12 oz bottle or below, the user has to put the raiser 700 into the bottom section 102 of the double-wall cooling apparatus before inserting the bottle of 12 oz 902. According to an embodiment herein, the double-wall cooling apparatus can hold different sizes of the bottle of 12 oz or below by slotting the top section quo the bottom section until it stops so that the bottle inside the double-wall cooling apparatus can be held securely and not moving around.

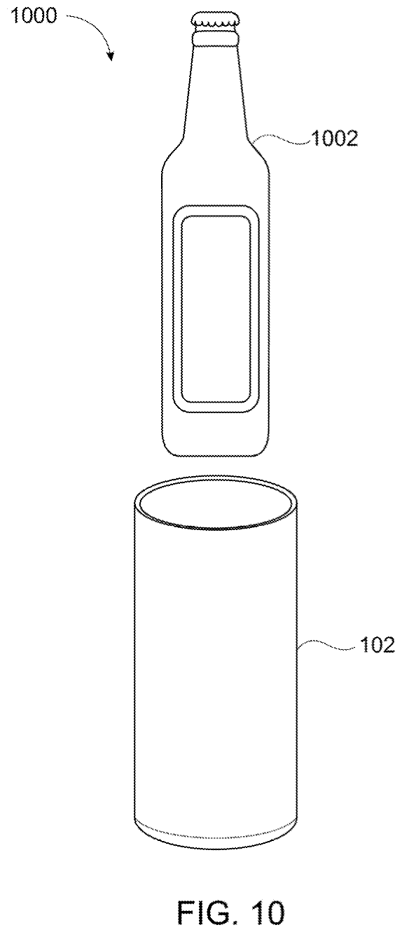

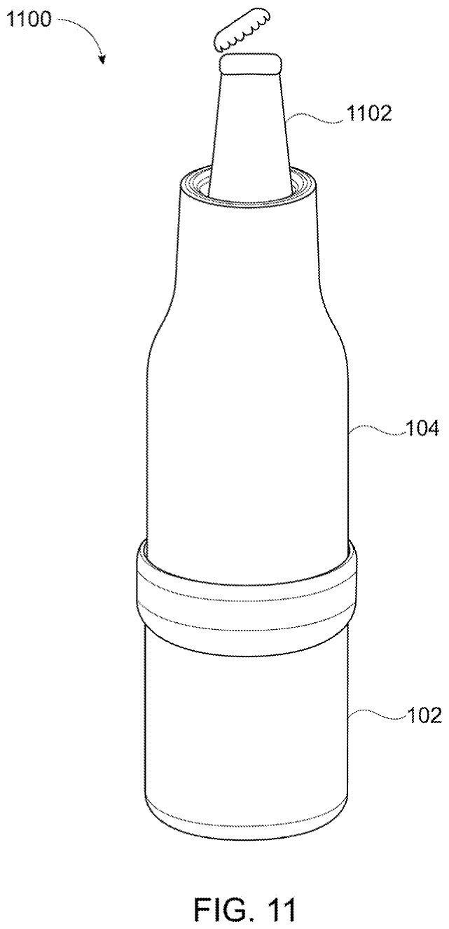

FIG. 10 illustrates a second perspective view 1000 of a double-wall cooling apparatus for use with a bottle of 16 oz 1002 size, in accordance with at least one embodiment. In the case of a 500 ml bottle, the user has to insert the 500 ml bottle 1002 directly into the bottom section 102 of the double-wall cooling apparatus. FIG. 11 illustrates a third perspective view 1100 of a double-wall cooling apparatus for use with a bottle 1102, in accordance with at least one embodiment. The user has to slot the top section 104 of the double-wall cooling apparatus without the cap, assembly onto the bottom section until it stops. Then the user has to hold the top section with one hand and turn the twist-lock counter-clockwise with the other hand to lock it securely. In order to drink the content of the bottle, the user can use the built-in bottle opener to remove the lid of the bottle.

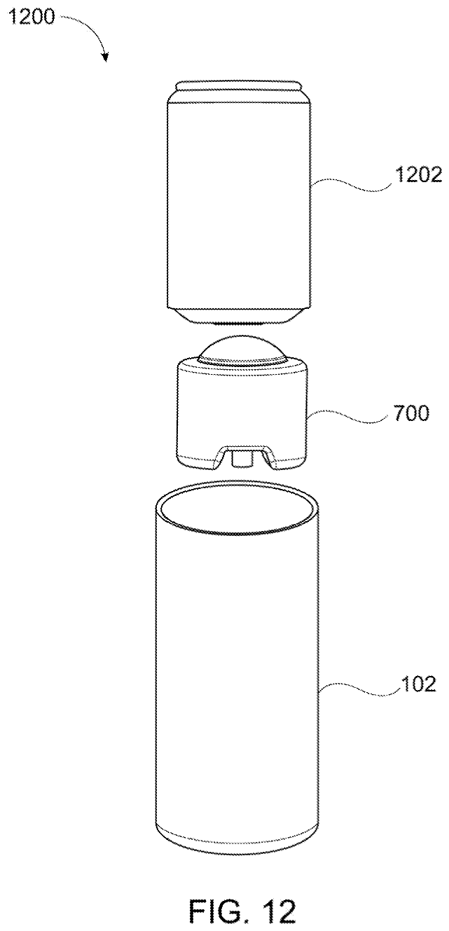

FIG. 12 illustrates a first perspective view 1200 of a double-wall cooling apparatus for use with a 12 oz can 1202, in accordance with at least one embodiment. In an embodiment, when the double-wall cooling apparatus is used with the raiser, the size of the can is 12 oz. In an embodiment, the top section of the double-wall cooling apparatus is not required for insulating the can. For the 12 oz can 1202, the user has to put the raiser 700 into the bottom section 102 before inserting the 12 oz can 1202. In an embodiment, the gasket 800 is slot over the 12 oz can 1202 to hold the 12 oz can 1202 securely.

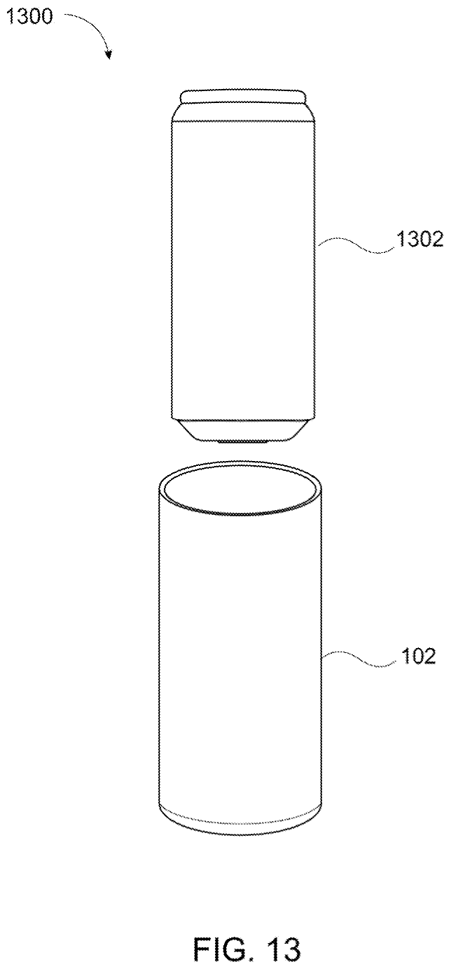

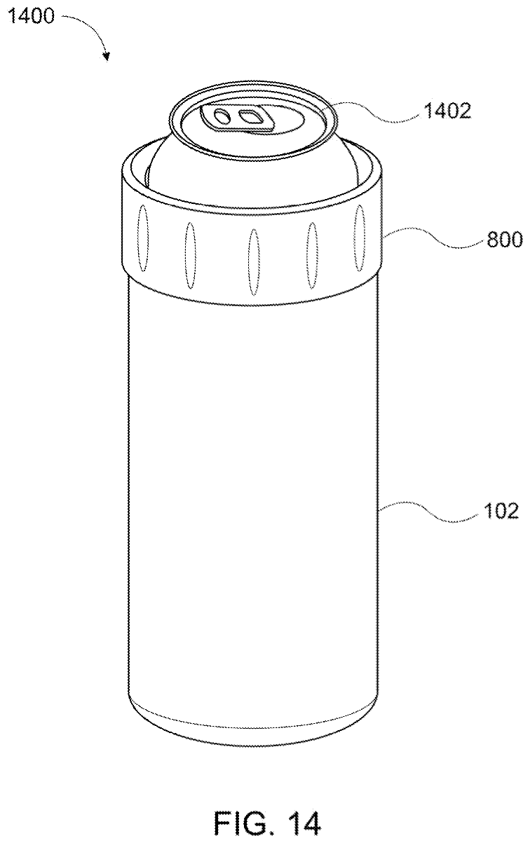

FIG. 13 illustrates a second perspective view 1300 of a double-wall cooling apparatus for use with a 16 oz can 1302, in accordance with at least one embodiment. For 16 oz can 1302, the user has to insert the 16 oz can 1302 directly into the bottom section 102. FIG. 14 illustrates a third perspective view 1400 of a double-wall cooling apparatus for use with a can 1402 in accordance with at least one embodiment. The gasket 800 is slot over the can 1402 to hold it securely. In an embodiment, the double-wall cooling apparatus and the components of the double-wall cooling apparatus are washed with warm, soapy water, then rinse with clean water and allow to air-dry before storing.

A person skilled in the art will understand that the double-wall cooling apparatus described herein for illustrative purposes and should not be construed to limit the scope of the disclosure. A person with ordinary skills in the art will appreciate that the apparatuses and devices have been illustrated and explained to serve as examples and should not be considered limiting in any manner. It will be further appreciated that the variants of the above-disclosed system elements, modules, and other features and functions, or alternatives thereof may be combined to create other rent apparatuses, systems, or applications.

While the present disclosure has been described with reference to certain embodiments, it will be understood by those skilled in the art that various changes may be made and equivalents may be substituted without departing from the scope of the present disclosure. Also, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A double-wall cooling apparatus for use with a beverage container, comprising:
a bottom section having a cylindrical shape to conform to the shape of the beverage container, wherein the bottom section comprises a closed bottom portion and an open-top portion;
a top section being inwardly contracted at the top to form an opening; and
a twist-lock to secure the top section and the bottom section, wherein the bottom section and the top section are detachably connected therewith.

2. The double-wall cooling apparatus as claimed in claim 1 further comprising a raiser placed at the closed bottom portion of the bottom section to raise the height of the beverage container having a size of 12 oz (ounces) or below so that opening of the beverage container is above the open-top portion of the bottom section.

3. The double-wall cooling apparatus as claimed in claim 1 further comprising a gasket to securely hold the beverage container onto the bottom section.

4. The double-wall cooling apparatus as claimed in claim 1 further comprising a cap assembly having an internally threaded skirt for closing an opening end of the beverage container.

5. The double-wall cooling apparatus as claimed in claim 4, wherein the cap assembly comprises a built-in bottle opener.

6. The double-wall cooling apparatus as claimed in claim 5, wherein the built-in bottle opener is placed on a top part of the cap assembly to facilitate a user to open the beverage container.
